(19) United States
(12) Patent Application Publication
(10) Pub. No.: US 2006/0010108 A1
(43) Pub. Date: Jan. 12, 2006

(54) Method and system for collecting and posting local advertising to a site accessible via a computer network

(76) Inventor: Joel Kenneth Greenberg, Gladwyne, PA (US)

Correspondence Address: DECHERT LLP, P.O. BOX 10004, PALO ALTO, CA, 94303, US

(21) Appl. No.: 10/890,064

(22) Filed: Jul. 12, 2004

(51) Int. Cl. G06F 17/30

(52) U.S. Cl. 707/3

(57) ABSTRACT

Method and system for collecting and posting advertisements aggregated from a plurality of sources in a database accessible via the Internet and searchable by criteria. This involves selecting an advertisement category from a group of advertisement categories, conducting periodic searches for advertisements in the selected advertisement category. retrieving, for each search, any advertisements that are found by that search, and storing the found advertisements in a database accessible via the Internet. Periodic searches automatically update the database dynamically with any newly found advertisements. Then a user gains access for searching the database for particular advertisements, wherein search results are filtered and collated based on criteria that includes category, locality and/or details of the advertisements. Search results are posted to the user on the web site.

### FIELD OF THE INVENTION

The present invention generally relates to collecting advertisements and conducting various searches and summaries on desired variables. More specifically, the present invention relates to a method and system for searching, collecting, sorting, aggregating and/or summarizing specific information through a central web page.

### BACKGROUND OF THE INVENTION

More and more advertisers and consumers are turning to the Internet to match products and services with consumers, just as more and more employees and employers are using the Internet to find suitable positions and candidates to fill them. Various forums for advertising that command large groups of viewers are available through general portals and specialized or niche portals, most of which have adopted a content category style. Some major general portals include Yahoo™, Excite™, Netscape™, Lycos™, CNE™, Microsoft™ Network, and America Online's™ AOL.com. Examples of niche portals include Garden.com (for gardeners), Fool.com (for investors), and SearchNetworking.com (for network administrators). Also, a number of large access providers offer portals to the Web for their own users. Portal sites typically offer a directory of Web sites, a facility to search for other sites, news, weather information, e-mail, stock quotes, phone and map information, and, sometimes, a community forum.

However, these services provide passive searching and browsing capabilities, and the information in them is limited to the information deposited in the websites. Search results are typically discrete and allow the viewers to examine them one at a time without being able to make any aggregate comparison of the retrieved data. Thus, passive searching and browsing capabilities are limited in their usefulness to viewers who seek more comprehensive information such as correlation between search results and more. For example, searching the classified ads section of a local, regional or national website for pianos for sale would not currently allow the user to aggregate and compare the search results from the separate sources; nor would such a user be able to manipulate the retrieved data to determine how much a used piano is selling for, say, in Pennsylvania versus Indiana. In another example, we assume that the piano manufacturer advertises new pianos on advertising media such as road-side billboards or signage. In this example, an interactive search system responds to a user inquiry, based on the locality of the advertising media, with the piano manufacturer's name or a link to its website. The information is obtained from a geo-coded database. Again, the information from such database is limited to what is deposited, and the reply is limited to the discrete result from the particular inquiry. The limited capabilities of such services limit the reach of advertisers and promoters and thus limit their success and the return on their investments.

As to employment, for example, there are currently several online tools and websites, such as Monster™ or HotJobs™, that offer a forum to employers for advertising jobs or for searching the database associated with the website for suitable candidates. The same websites allow employees to post their resumes and search for available jobs posted on the web sites. However, all these websites have a limited database and can only provide searching and browsing capabilities of the information deposited in their website by prospective employers and employees. Thus, the reach of these web sites is limited by their success in promoting their web site and on the popularity of their services. Furthermore, as with all other commercial advertising, in cases where postings on the web site are limited to people or entities that pay to list their advertisements, the offerings on the site available to prospective sellers, buyers, employees, employers and the like may be further limited by how successful the web site is in marketing and selling its services.

### SUMMARY OF THE INVENTION

The present invention is based, in part, on the understanding that it is possible to have a system and method where users gain access to local, regional and national advertisements or data from a greater number of sources. These sources include local and national newspapers and magazines (including specialized and trade magazines), websites of all kinds and other such sources, where advertisements or data in categories or regions of interest are obtained by active means and updated in a dynamic way.

For example, the present invention targets databases that are limited in their information-gathering capabilities because they are passively dependent on the input of subscribers that pay for the services of the businesses that maintain such databases. In one embodiment of the present invention, advertisements related to categories of interest are dynamically and periodically electronically searched for the wide variety of sources described above. The information is then stored in a database, where access to the data is provided to users using various on-line search tools, where filters are available to narrow the scope of the searches based at least on the geographical source of advertising (e.g., Honda Accords for sale in the metropolitan Philadelphia region) and the category of advertising (e.g., Honda Accords for sale everywhere), and where the advertising and/or category of advertising itself can be aggregated and summarized for the user.

A representative embodiment of the present invention provides for a method of searching, collecting, posting and presenting advertisement from the various sources on a central database, accessible via the Internet and searchable by geography, advertisement category and various details of the advertisement. Such details include, for example, price, age or condition with respect to goods for sale, or salary or required experience with respect to jobs. To that end, the method further includes selecting a category of advertisement from a group of advertisement categories, including, without limitation, product and services advertisements, job advertisements and singles advertisements, and summaries of each of the variables, such as a job salary or location or product price or location, found in each of the advertisements. Also, in accordance with such method, periodic searches of the Internet are then conducted for the selected advertising category without further action by the user, thereby automatically updating the stored advertisement dynamically. Then, the corresponding data is retrieved and stored on a database accessible via the Internet. The posted (stored in the database) advertisements may then be filtered at least based on advertisement category, advertisement details and by locality of a stored advertisement source.

While searches can be tailored for the individual advertisement being sought, more importantly, the search can also provide, by way of example, a summary of all relevant details, such as all salaries in a particular region of the country for a particular job. Not only is a user allowed to gain access to the database for searching of the data therein, where the search results may be limited or filtered by the category or the locality of the source of the advertisement as well as advertisement details, but a user is also allowed to determine market trends in geographical regions or market areas. Moreover, the present invention is not merely limited to searching job advertisements over the internet but instead can be applied to a host of searches for any type of data that is included in newspapers, magazines, websites and other such sources.

According to one embodiment of the invention, a system is implemented that is operative to perform the foregoing, including searching, collecting and posting advertisements aggregated in a database accessible via the Internet and searchable by criteria. More specifically, in one implementation the system includes a central processor operative to manage collecting, sorting, rearranging, storage, posting, and summarizing variables found in advertisements, wherein the collecting, sorting, rearranging, posting, and summarizing is guided by criteria, including advertisement category, geographic area, age, price or salary, and wherein the processor includes a parser for parsing and analyzing the collected advertisements. As designed, the system includes an automated search engine operative, under management of the central processor, to periodically search the Internet for advertisements based on search criteria, including the advertisement categories, geographic areas and advertisement details. To that end, an operator terminal is provided for inputting and providing to the central processor the search criteria. Also included is a database that is managed by the central processor and that is operative to store collected advertisements. The database is searchable by filtering search results based on the criteria. Furthermore, a user terminal controllable by the user is operative to communicate with the central processor through the Internet and search, retrieve, post and aggregate advertisements from the database, wherein the search is based on the criteria.

Hence, as can be appreciated, one aspect of the present invention is having access to multiple sources of advertising for desired products and services.

Yet another aspect of the present invention is reliance on active means of collecting advertising on the desired products and services.

An additional aspect of the present invention is having access to locally relevant advertising that is regularly updated.

A further aspect of the present invention is being able to search and organize aggregated search results according to criteria.

These and other features and aspects of the present invention will become better understood from the description herein, appended claims, and accompanying drawings as hereafter described.

### BRIEF DESCRIPTION OF THE DRAWINGS

The accompanying drawings, which are incorporated in and form a part of this specification, illustrate embodiments of the teachings and, together with the description, serve to explain the principles of the teachings. Throughout the drawings, the same callout numbers are used to describe the same or similar elements.

FIG. 1 is a flow of chart of the advertisement collection, storage and presentation according to an embodiment of the present invention.

FIG. 2 is a system according to one embodiment of the present invention.

### DETAILED DESCRIPTION OF THE PREFERRED EMBODIMENTS

The teachings of the present invention address a web site where users may access up-to-date local advertisements from multiple regions or multiple categories of offerings. The advertisements available on this web site are collected using an active method of searching the Internet and seeking offerings in the geographic regions and categories of interest. The teachings of the present invention address the problems of advertisement databases that are passive and thus limited in the amount of data they can provide their users. In a scenario such as the one where a person moving to a new city or neighborhood is looking for in a variety of information related to local offerings, such as local jobs, retail establishments, apartment or home rentals, car dealers, and services such as insurance. The teachings of the present invention allows a single web site to provide advertisement in the various categories, all corresponding to a particular locality.

In an alternative embodiment, a single website may be dedicated to a local area or presenting one category of local advertisement such as job offerings, for an entire region. In either case, the method and system of the present invention allows a user to have access to local advertisements in a user-selected area, or all local advertisements in user-selected category. And, advantageously, the information available is not limited by the information users have voluntarily provided to the web site.

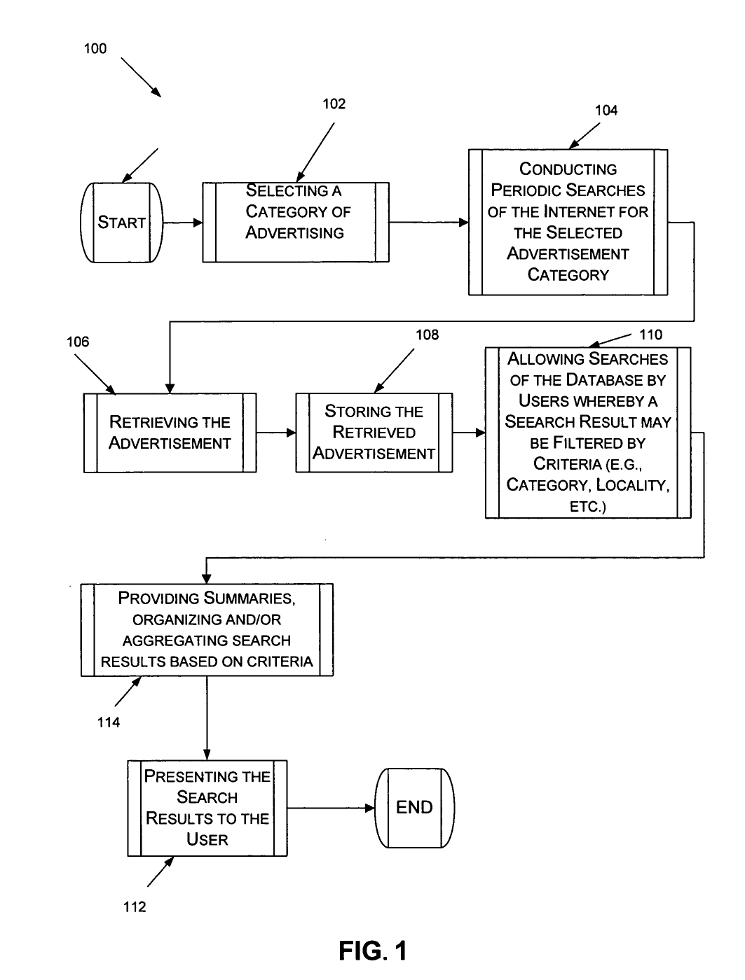

Accordingly, FIG. 1 shows s representative method that embodies the principles of the present invention. As shown, the process 100 starts with the selection of at least one category of advertisements to be searched in operation 102. The criteria defining the categories or regions to search are entered by a system operator based on its associated type of web site. The various categories of advertisements may include advertisements for jobs, singles ads, rental property ads, home or businesses for sale, cars for sale, estate sales, etc.

Based on the selection of the advertising category to be searched, in operation 104, at least one search engine periodically searches the Internet, looking for advertisements corresponding to the selected category or categories. The search engine may include logic that enables it to parse and analyze the content of the files or web pages it comes across, and identify the type of advertisements it may contain and the category it may correspond to. The periodic searches allow updating of the information accessible through the web site. In one embodiment of the present invention, a single web site may be used to represent various categories of local advertisements, and thus a user who intends to use the web site will potentially have access to several categories of local advertisements. In another implementation there is a particular website for each category or group of categories.

In operation 106, at least one search engine retrieves advertisements within the categories and from the locality of interest, providing it to a database of information associated with the web site. The database is typically accessible by the user via the Internet. Additional information may be manually retrieved by converting local advertisements not available in an electronic format, into an electronic file and presenting that information to the database. Although it provides additional value, this method is cumbersome and, indeed, it is becoming less and less necessary, because increasingly, even the smallest local newspapers and publishers are publishing a part of their newspaper or magazine online.

In operation 108, the retrieved advertising is stored in the database associated with the web site. In one embodiment, the retrieved data is reorganized and sorted according to advertisement categories, regions and other such classifications required by database, to allow for an efficient search of the database.

In operation 110, user's are allowed access to the advertisements stored on the central database, by accessing the system through its associated web site. Using a graphical user interface (GUI) the user may conduct various searches of the database. With GUI, the gathered advertising information in the database can be manipulated and presented to the user in a number of useful ways, including through aggregation, filtering, sorting and summarizing. For example, the user may select filters to narrow and specify its search through the database. An example of such filter may be based on a category of advertising or a particular region definition, such as city or county. The user may chose the option of aggregating the query results, and/or summarizing them based on selected criteria. Aggregation, sorting and summarizing can produce, for example, all the advertised prices of product in a particular category in a particular region or county for a particular brand. In operation 112, the search results are collected, filtered and presented to the user.

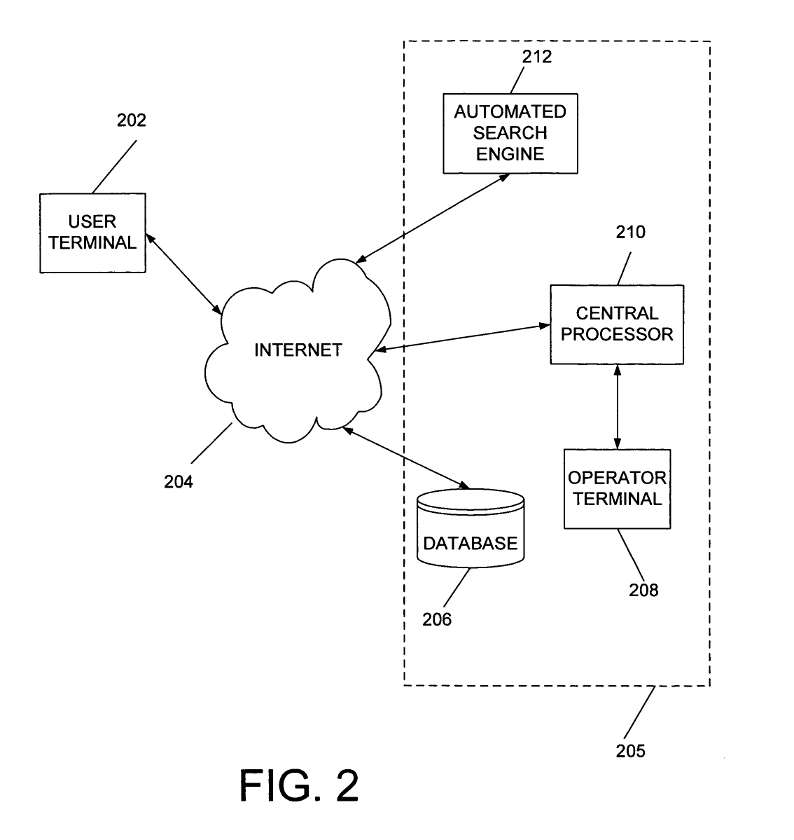

FIG. 2 is a system implemented according to one embodiment of the present invention. As shown, system 200 includes at least one user terminal 202, a central processor 210 and an associated database 206, and at least one automated search engine 212. The search engine is operatively linked with the central processor 210 and is configured for searching advertisements of particular interest. In this configuration, the foregoing components of the system 200 are connected to the Internet 204. The central processor 210 receives operator instructions through an operator terminal 208.

The user terminal 202 may be in a general purpose computer or any other type of device that can provide Internet connectivity. The database 206 is used to store the collected local advertisements and is associated with the central processor 210 that controls the overall operation of the system. In one embodiment of the present invention, the database 206 is located on a single physical machine. In an alternative embodiment, the database 206 may be a distributed system, residing on multiple physical systems (server or server cluster), in communication with the central processor 210 through the Internet and any combination of intranet, LAN (local area network), MAN (municipal area network), SAN (system area network) and the like. At least one operator terminal 208 may be used to input commands and control the operation of the system 210. The processor 210 includes at least one search engine 208. The at least one automated search engine 210 operates as an autonomous robots and can peruse the Internet in search of local advertisements.

The type of advertisements to be retrieved by the automated search engine 212 and the sources of the such advertisements are based on the criteria provided by the operator 208 such as the advertisement category and location of the source of the advertisement.

The type of advertisement to search for, the geographic location of the advertiser or the offer of interest, and the frequency of updating of the information may all be selected as criteria of operation by the system operator (via 208).

In sum, the present teachings address the collection and presentation of local data accessible via the Internet from a web page. Although the present invention has been described in considerable detail with reference to certain preferred versions thereof, other versions are possible. Therefore, the spirit and scope of the appended claims should not be limited to the description of the preferred versions contained herein.

We claim:

1. A method of collecting and posting advertisements aggregated from a plurality of sources in a database accessible via the Internet and searchable by criteria, comprising:
selecting an advertisement category from a group of advertisement categories;
conducting periodic searches for advertisements in the selected advertisement category;
retrieving, for each search, any advertisements that are found by that search;
storing the found advertisements in a database accessible via the Internet, wherein the periodic searches automatically update the database dynamically with any newly found advertisements;
providing access to a user for searching the database for particular advertisements, wherein search results are filtered based on criteria which includes one or a combination of advertisement category, locality of advertisement sources, and an advertisement detail; and
posting the search results to the user.

2. The method of claim 1, wherein the step of storing the found advertisements includes:
sorting and rearranging the retrieved advertisements based on the criteria; and
storing the sorted and rearranged advertisements in the database.

3. The method of claim 1, wherein the step of retrieving the found advertisements includes:
electronic collection and retrieval of advertisements in electronic format from web sites via the Internet; and
collecting advertisements from sources not available on the Internet in an electronic format and converting these advertisements to electronic format.

4. The method of claim 1, wherein the step of providing access to a user includes summarizing the filtered search results, wherein each summary collates the filtered search results based the criteria.

5. The method of claim 1, wherein the advertisement detail is one of a plurality of attributes including type, price, age, condition, color, salary, field of expertise, or years of experience.

6. The method of claim 1, wherein the advertisement categories include job offers, singles introductions, professional or finance services, retail, wholesale or industrial materials or products, properties for sale or rent, used merchandise, or social or entertainment events.

7. A system for collecting and posting advertisement aggregated from a plurality of sources in a database accessible via the Internet and searchable by criteria, comprising:
a central processor operative to manage collecting, sorting, rearranging, storage, and posting of advertisements, wherein the collecting, sorting, rearranging and posting is guided by criteria which includes one or a combination of advertisement category, geographic area and an advertisement detail, and wherein the processor includes a parser for parsing and analyzing the collected advertisements;
an automated search engine operative, under management of the central processor, to periodically search the Internet for advertisements based on the criteria;
an operator terminal for inputting and providing to the central processor the criteria;
a database managed by the central processor and operative to store collected advertisements dynamically, the database being accessible and searchable by filtering and collating search results based on the criteria;
a user terminal controllable by a user and operative to communicate with the central processor through the Internet and search, retrieve, and post advertisements from the database, wherein the search is based on the criteria.

8. A computer system for collecting and posting advertisements aggregated from a plurality of sources in a database accessible via the Internet and searchable by criteria, the computer system having a processor and memory embodying program code with instructions for causing the processor to perform the steps of:
selecting an advertisement category from a group of advertisement categories;
conducting periodic searches via the Internet for advertisements in the selected advertisement category;
retrieving, for each search, any advertisements that are found by that search;
storing the found advertisements in a database accessible via the Internet, wherein the periodic searches automatically update the database dynamically with any newly found advertisements;
providing access to a user for searching the database for particular advertisements, wherein search results are filtered based on criteria which includes one or a combination of advertisement category, locality of advertisement sources and an advertisement detail; and
posting the search results to the user.

9. The computer system of claim 8, wherein the code for storing the found advertisements further includes code for causing the processor to perform the further steps of:
sorting and rearranging the retrieved advertisements based on the criteria; and
storing the sorted and rearranged advertisements in the database.

10. The computer system of claim 8, wherein the code for retrieving the found advertisements includes code for causing the computer system to perform the further steps of:
electronic collection and retrieval of advertisements in electronic format from web sites via the Internet; and
collecting advertisements from sources not available on the Internet in an electronic format and converting these advertisements to electronic format.

11. The method of claim 8, wherein the advertisement categories include job offers, singles introductions, professional and finance services, retail, wholesale or industrial materials and products, properties for sale or rent, used merchandise, and social and entertainment events.

12. A method of collecting and posting data aggregated from a plurality of sources in a database accessible via the Internet and searchable by criteria, comprising:
selecting an advertisement category from a group of advertisement categories;
conducting periodic searches via the Internet for advertisements in the selected advertisement category;
retrieving, for each search, any advertisements that are found by that search;
storing the found advertisements in a database accessible via the Internet, wherein the periodic searches automatically update the database dynamically with any newly found advertisements;
providing access to a user for searching the database for particular data, wherein search results are filtered and collated based on criteria that includes one or a combination of advertisement category, advertisement sources locality and an advertisement detail; and
posting the search results to the user.
